(19) United States
(12) Patent Application Publication
(10) Pub. No.: US 2024/0046364 A1
(43) Pub. Date: Feb. 8, 2024

(54) INSURANCE POLICY GENERATION PLATFORM

(71) Applicant: Butler at Your Service, Burnaby (CA)

(72) Inventors: Gary Cheng, Burnaby (CA); Hamed Noori, Burnaby (CA); Kevin Gu, Burnaby (CA)

(73) Assignee: Butler at Your Service, Burnaby (CA)

(21) Appl. No.: 18/230,753

(22) Filed: Aug. 7, 2023

Related U.S. Application Data
(60) Provisional application No. 63/396,164, filed on Aug. 8, 2022.

(51) Int. Cl. G06Q 40/08; G16Y 20/10

(52) U.S. Cl. CPC G06Q 40/08; G16Y 20/10

(57) ABSTRACT

The present system is a data-driven platform to generate customized insurance policies for clients. The customization includes but is not limited to insurance conditions, pricing, and duration. The platform involves three layers of data processing pipeline: data collection layer, feature selection layer, and policy generation layer. The data collection layer gathers data from different sources. The feature selection layer selects the set of viable features per client for policy generation. Finally, the policy generation layer generates a customized and personalized insurance policy based on the preceding process.

### CROSS REFERENCE TO RELATED APPLICATION

This application claims the benefit under 35 U.S.C. § 119(e) of U.S. Provisional Application No. 63/396,164 entitled “INSURANCE POLICY GENERATION PLATFORM” filed Aug. 8, 2022, which is incorporated herein by reference.

### BACKGROUND

Insurance policies, traditionally, have been generated manually after collecting survey information between persons. In the modern marketplace, having a system and method to collect information automatically from policy holders could provide an increased level of convenience. Implementing artificial intelligence and machine learning methodologies with such a system would enable insurance providers to generate more accurate policies that are better tailored to each client.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The present system is a data-driven platform to generate customized insurance policies for clients. The customization includes but is not limited to insurance conditions, pricing, and duration. The platform involves three layers of data processing pipeline: data collection layer, feature selection layer, and policy generation layer. The data collection layer gathers data from different sources. The feature selection layer selects the set of viable features per client for policy generation. Finally, the policy generation layer generates a customized and personalized insurance policy based on the preceding process.

The data courses for the data collection layer of the platform are based on Internet-of-things (I0T) sensors, security alarm systems, and CCTV cameras that are installed inside and outside the property. There are certain APIs to query the mentioned databases. Add data can be fetched in real time or through historical means for further processing.

The sensors can include humidity sensors to monitor the ambient humidity of the residential structure, temperature sensors for indoor temperature, and a variety of other sensors. These sensors can be added to the platform to monitor fire, gas leakage, water leakage, mold accumulation, door lock state, window lock state, and motion detection. The closed circuit television technology can be implemented to assist in motion detection, tamper detection, and artificial-intelligence based object detection algorithms. The security alarm system can be configured to detect unauthorized entrances.

The feature selection layer uses artificial intelligence or machine learning to obtain the most relevant collected data streams and combination of multiple data streams. These can be gathered as the features for a client based on the property's specifications, owner's specifications, and environmental specifications. The features are used as the input for the policy generation layer of the platform.

The policy generation layer uses an artificial intelligence algorithm that utilizes both the historical and real-time data streams for the selected feature to offer a fully customized insurance policy in terms of the conditions, price, and duration. The artificial intelligence algorithm learns patterns of data streams to generate a policy that jointly minimizes the risk for the insurance company and the risk/price for the property owner.

The policy generation layer is equipped with an artificial intelligence based false data detection function to snuff out false claims and false/manipulated data. The artificial intelligence algorithm learns from normal data streams using historical data to detect false collected data and claims in real time.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is an embodiment of the insurance policy generation platform

FIG. 2 is a process associated with an embodiment of the insurance policy generation platform

### DETAILED DESCRIPTION

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

The present system is a data-driven platform to generate customized insurance policies for clients. The customization includes but is not limited to insurance conditions, pricing, and duration. Insurance providers traditionally conduct researches on a potential client and issues surveys for information vital for the police creation process. This requires a certain level of cooperation and initiative on all members of the party. The information can be difficult to obtain, or obtained in an untimely manner, or simply false or manipulated for the benefit of certain clients. Further, the information gathering and policy evaluation process often is carried out through multiple platforms or processes, decreasing the ideal consistency needed for insurance creation.

The present system is an algorithm that collects the data required for insurance policies, selects the appropriate features based on user input and the collected data, and generate a customized policy that aims to minimize cost/risk ratio for both the insurance company and the clients. The system can be implemented as an algorithm, a software architecture, or a computer/network implemented system. In the following descriptions, an algorithm, platform, architecture, or system can be used to infer to the present system.

The system can be implemented through a cloud network, with user interfaces on various devices to enable user interaction at different levels. In the exemplary embodiment of the present system being a software architecture, the policy providers and the clients (or property owners) can access the present system through personal or work computers, mobile phones, tablet devices, or other personal electronic devices. The various features required for the system's function can be implemented through a network of devices that are connected to the same cloud network, or a collection of cloud networks.

The present system is intended to be used to calculate the policy parameters based on the information given. There are a variety of methods for data collection and feature selection, and the overarching concept for the system allows it to evaluate the data against the requirement to create tailored policy recommendations. As it will become clear in the following descriptions, the system is implemented with algorithms that would learn from the collected data and determine a pattern of behavior in order to better tailor the policy to each user.

The platform involves three layers of data processing pipeline: data collection layer, feature selection layer, and policy generation layer. The data collection layer gathers data from different sources. The feature selection layer selects the set of viable features per client for policy generation. Finally, the policy generation layer generates a customized and personalized insurance policy based on the preceding process.

Each layer can be implemented on a device capable of computer processing, or collectively on a computational device. Alternatively, each policy layer would reside in their own allocated space on a network. In all iterations of the present system, each policy provider, agent, client, property owner, or any interested party can access the platform through their prepared personal devices. The platform creates a number of access levels for each platform layer. The allocation and disposition of each layer is dependent on the specific needs of each application.

In an exemplary embodiment, the data collection layer is implemented in a property for which a client wishes to obtain insurance coverage from a policy provider. The data collection layer can be an aspect of the algorithm with data collection nodes implemented in the client property. The data collection layer connects to a number of data collection nodes in a property such as a home or an office building. These data collection nodes can be humidity sensors, temperature sensors, fire alarms, smoke detectors, gas leak detectors, water leak detectors, mold detectors, door lock mechanism, window lock mechanism, motion detectors, and more. The number and function of data collection nodes depend on the condition of the property and the requirement for the client, but it is generally understood that any data collection device that can be implemented on a property can be incorporated into the data collection layer.

Artificial intelligence based object detection algorithms can be implemented on the network to supplement the existing data collection nodes. The algorithm would assist the security systems in detecting unauthorized entrances.

The data detection layer can be implemented as a cloud based network to connect the devices on a property. The data collection nodes can be implemented through Internet-of-Things (IoT) methodologies. The data detection layer is intended to be upgradeable and adaptable to the state of art technology in data collection.

The data collection layer can also incorporate existing databases. In addition to real time data collection through the number of sensors and devices connected through the network, the data collection layer can collect existing data on the network through connected databases. These databases can be standalone databases that store pertinent information for a property. Alternatively, the databases can be connected elements of the data collection devices on the network. There are certain APIs to query the mentioned databases. These databases can provide historical data in addition to the real time data from other devices on the network.

The feature selection layer uses artificial intelligence or machine learning to obtain the most relevant collected data streams and combination of multiple data streams. These can be gathered as the features for a client based on the property's specifications, owner's specifications, and environmental specifications. The policy provider can access the feature selection layer and provide the necessary specifications, which will direct the feature selection layer to sort through the data collected through the data collection layer to better identify the pertinent information.

As the data collection layer obtains information from real time interaction with the data collection nodes or historical data from the databases, the most relevant data gathered within will be sorted by the features selection layer. With the aid of artificial intelligence algorithms, the features selection layer is able to identify the information that is helpful in creating a customized insurance policy. In one example, the features selection layer can focus on the temperature data during the time when motion sensor indicates presence within the property. This provides the policy provider with insight to the temperature setting preference of the client, and correlate energy expenditure and hazard potential during active time period within the period. Instead of filtering through the collected data as a whole, the feature selection layer is able to direct the focus to the more significant data on the network. The features are used as the input for the policy generation layer of the platform.

The policy generation layer uses an artificial intelligence algorithm that utilizes both the historical and real-time data streams for the selected feature to offer a fully customized insurance policy in terms of the conditions, price, and duration. The artificial intelligence algorithm learns patterns of data streams to generate a policy that jointly minimizes the risk for the insurance company and the risk/price for the property owner

The policy generation layer is configured to determine a pattern of behavior based on the information gathered from the data collection layer and the features selection layer. Examples of patterns of behavior are: how often people are at home; what time they come home; length and frequency of their vacation; temperature setting preference; electronic usage habit; general activity level within the property pertaining to risk assessment in an insurance policy perspective.

Artificial intelligence algorithms and methodologies are implemented in the policy generation layer in order to evaluate the data stream effectively. As data is collected in real time through the network of IoT capable devices, historical data are gathered as well through the databases on the network. Such quantity of data is further filtered and parsed through by the features selection layer to present the most relevant information as input for the policy generation layer. In turn, the artificial intelligence algorithm is able to evaluate the data stream to determine a pattern of behavior. Historical data is used to develop a baseline for the artificial intelligence algorithm, and real time data is used to update the baseline and implement the training process for the algorithm. The combination of both real time and historical data allows the artificial intelligence algorithm to develop a pattern of behavior, and continuously improve the accuracy in data assessment and pattern forecast.

The policy generation layer would be able to identify the relevant data from the data collection layer with parameters set forth by the features entered through the features selection layer. Together, the data and features allow the policy generation layer to determine the appropriate outcome based on the pattern established therein. The policy generation layer would be able to utilize artificial intelligence algorithm to establish a schedule of events to be expected. As an example, the policy generation layer would be able to identify that the energy expenditure increases as the motion sensor activates during set time of the day, and would infer that at certain time of the day, activities within the property increases to demand higher energy usage within. The type of energy expenditure would then be extrapolated to assess relevant risk factors from an insurance policy standpoint. Should the heating elements on the property be more active during certain time of the day or periods of the year, the policy generation layer would be able to map out such heightened usage. Accordingly, an insurance policy would be tailored to better reflect the particular pattern displayed.

By examining the data that organized by the features against the patterns of behavior created, the policy generation layer is configured to generate a policy output that is congruent to the behavior of the client. As an example, if the policy generation layer determines that the client's property is unoccupied for a certain period during the day, energy related policy elements would be decreased whereas security based elements would be heightened against potential trespassers. Similarly, insurance policy can be tailored to lower the coverage during an extended period of absence on the property as the client goes on vacations. As the artificial intelligence algorithm continues to improve during the process, more accurate forecast on the behavior can be made without client input. This helps eliminate excess reporting for the client, and provides the policy provider with the ability to accurately assess the risk factor associated with the client. The policy output generated created by the policy generation layer will be a reflection of the artificial intelligence algorithm's ability to assess human behavior, and will be one that jointly minimizes the risk for the insurance company and the property owner.

The policy generation layer is equipped with an artificial intelligence based false data detection function to snuff out false claims and false/manipulated data. The artificial intelligence algorithm learns from normal data streams using historical data to detect false collected data and claims in real time. It is foreseeable that efforts to tamper with the data collection process is possible in an attempt to direct the platform to generate a policy output that is more favorable that it otherwise would be. The artificial intelligence algorithm will be constructed to include functions that would detect abnormalities in a data collection process. Once the pattern is determined and a baseline has been established, the policy generation layer would be able to forecast potential input from the data collection layer. An appropriate margin would be provided for the forecast, such that data that fall outside of the margin would be subjected to review. In one exemplary embodiment, the policy generation layer would be able to reject the abnormal data automatically based on the machine learning result. Alternatively, the policy generation layer would present the abnormal data to policy providers for secondary and manual evaluation. The abnormal data detection function can be carried out as the policy generation layer generates a report as an output, or it can be implemented as a check function to reject or isolate abnormal data in real time.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

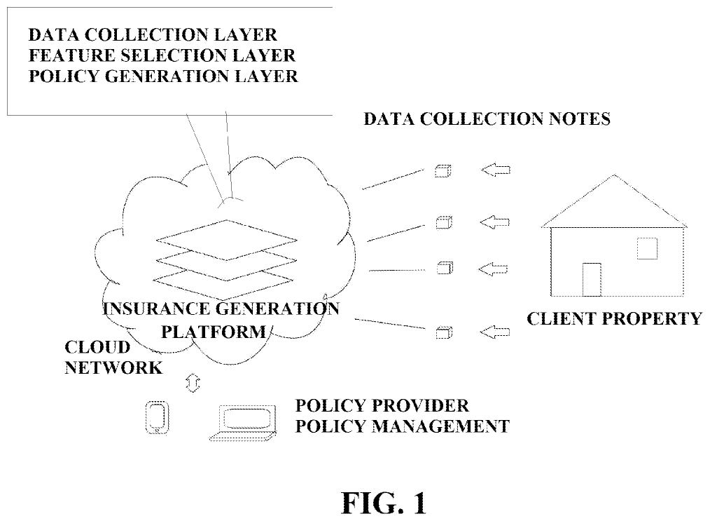

Referring to FIG. 1, an exemplary embodiment of the insurance policy generation platform is shown. The platform consists of a data collection layer, a feature selection layer, and a policy generation layer. The platform resides on a cloud network in this embodiment. In other embodiments, the platform can be distributed as needed in other configurations on a network.

Each layer of the insurance generation platform can be implemented as a part of a complete program. The platform can be implemented as a complete software architecture with allocated resources for each layer. Alternatively, each layer can be implemented as a standalone program with individual access and communication protocols. It is understood that a person with ordinary skills in the art would be able to implement the insurance generation platform in the appropriate programming structure that best benefits the user.

The cloud network connects the insurance generation platform with both the policy provider and the client property. In the exemplary embodiment, the insurance generation platform is an algorithm or software architecture that can be implemented on various personal computing devices. The insurance generation platform can be accessed by the policy provider or the client through their respective devices, through an application programming interface or user interface. The devices allow users to interact with the respective aspect of the insurance generation platform depending on access level.

The insurance generation platform is connected to the client property, which includes a number of data collection nodes that can be connected directly to the cloud network. The data collection nodes can be located directly within a building structure or a piece of real estate property within a certain boundary. The data collection nodes can include any of the sensors or devices that are designed to collect relevant data and information from the premises. In addition, the data collection nodes can be databases which connect to other data collection devices. The connection method allows the data collection layer to obtain both real time data from the devices and historical data from existing databases.

The data collection nodes or data resources for the data collection layer include sensors and data collection devices that have Internet-of-things (IoT) capabilities. These enable the insurance generation platform to collect data in real time directly from the IoT devices. These devices can include but are not limited to: humidity sensors, temperature sensors, fire alarms, gas leakage detectors, water leakage detectors, mold detectors, door lock, window lock, motion sensors, and closed circuit television cameras. The CCTV modules can be further supplemented with artificial intelligence based object detection algorithms, implemented through and provided by the insurance generation platform, to assist in detection unauthorized entrances on the premises.

The data collection nodes can be implemented on the same cloud network that the insurance generation platform resides on, or it can be implemented through a separate network with shared access points to the cloud network. The exact configuration and orientation of the data collection nodes and the insurance generation platform are modifiable to each user's specific needs.

In operation, the data collection layer collects real time and historical data from the data collection nodes. The data collection nodes obtain relevant information through each individual devices and transmit the information to the platform. The information is gathered from the client property, which can be a residence, office building, or a real estate property within a certain boundaries. The information gathered can be stored on a databased implemented on a cloud network server. The information, alternatively, can be streamed to the insurance generation platform without being stored directly, thereby decreasing the required storage space on a network.

The policy provider can engage in policy management through the interaction with the insurance generation platform, with emphasis on the feature selection layer and the policy generation layer. The policy provider supplies a set of parameters as input for the feature selection layer. These parameters establish the standard for which the information from the data collection nodes can be evaluated. The feature selection layer utilizes its own artificial intelligence methodologies to interpretate the policy provider's set of parameters to select the appropriate features. For example, if the policy provider enters the parameter to direct the platform's focus on climate control devices on the client property, the feature selection layer would direct the focus of the platform for the relevant sets of information from the data collection nodes: data from heating elements, air conditioning units, humidifiers, gas leakage detection, etc. The artificial intelligence algorithm can be trained to better direct the focus of the platform as more interaction takes place between the platform and the policy provider, such that the feature selection layer can forecast the required feature for certain clients. The feature selection layer then generates a features output to the policy generation layer.

The policy generation layer collects the features output as its own input in the process to generate a customized policy. The data collection layer also transforms the data collected through the data collection nodes into data inputs for the policy generation layer. Artificial intelligence algorithm is implemented on the policy generation layer in order to analyze the pertinent inputs and create customized output. The artificial intelligence algorithm in the exemplary embodiment is implemented through machine learning methodologies, but it is understood that the present platform and architecture can be constructed with any of the known artificial intelligence methodologies available at the time.

The policy generation layer utilizes the artificial intelligence algorithm to determine a pattern of behavior for the client. The policy generation layer evaluates the features input and the data input to evaluate a schedule of actions and events that would allow a pattern to be created. As an example, the policy generation layer is able to determine the time of entry and absence of the client on the property, the extended vacation period that takes place at certain time of the year, and climate control devices setting preferences for certain time of the day or the year. The policy generation layer can determine the electronic device usage pattern and calculate the accurate consumption rate for the client, and assess the risk factor associated with such consumption rate. The policy generation layer is then able to conduct a thorough survey of the property based on the policy provider's specifications without requiring manual input from the client.

The policy generation layer is able to in turn create a customized policy output based on the behavior of pattern. Because the pattern more accurately reflects a client's actual behavior on the property, a better tailored policy can be made to minimize the cost-risk factor for both the policy provider and the client. As an example, the policy generated can reflect an increase in energy consumption based coverage during the more active period of the year, or an increase in theft coverage during the absence period on the property. This platform intends to decrease the cost for a more accurately assessed risk factor for the client.

The policy generation layer is further equipped with artificial intelligence based algorithm to detect false claims, false data, or manipulated data. The policy generation layer can used the learned pattern of behavior to determine whether a particular set of data entry is abnormal and potentially false. As the policy generation layer continues to assess the incoming data from the data collection nodes against the parameter input by the policy provider, the policy generation layer is able to determine a margin of acceptable accuracy for each data collection nodes. For example, a sudden decrease in air conditioning energy consumption during a time when the property is expected to have occupancy and activity levels would imply a malfunction or data manipulation. The policy provider can also supply sets of boundaries for certain data points, so that the artificial intelligence algorithm can improved over time for data detection.

The artificial intelligence algorithm can learn from the normal data streams using the historical data collected from the databases to identify potential false data in real time. The false data detection function can take place as part of the policy generation output, or in real time as the policy generation layer is still evaluating the data collection process. The platform can be utilized as ongoing support to monitor the client property during policy coverage period. This allows the platform to alert the policy provider and the client when abnormal data entries are detected.

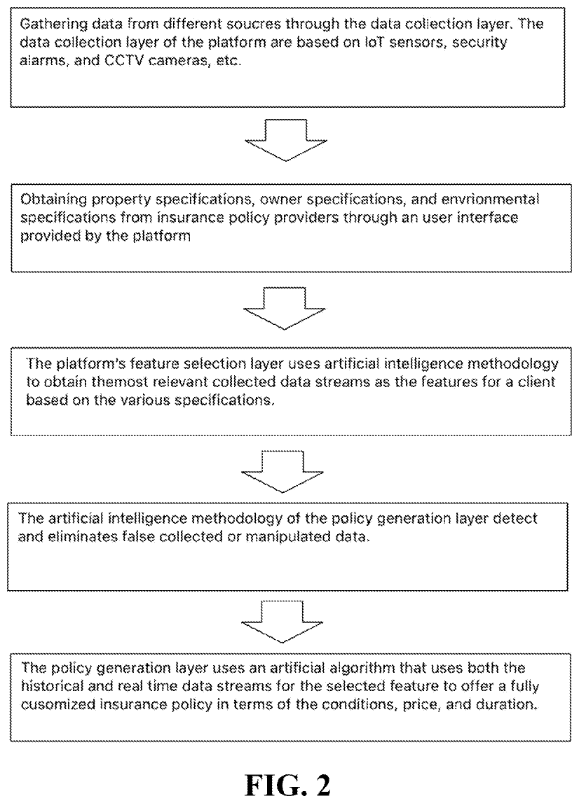

Referring to FIG. 2, an exemplary process for the insurance policy generation platform is shown. The process begins with the gathering of data from different sources through the data collection layer. The data collection layer of the platform are based on IoT sensors, security alarms, CCTV cameras, etc. The data can be collected in real time from the devices, or historical data can be gathered from the existing databases that are connected on the network.

Next, the features generation layer obtains property specifications, owner specifications, and environmental specifications from the insurance policy providers through a user interface. The platform can provide an application program interface on computer devices accessible by the policy providers. These specifications are treated as parameters for the features selection player to focus on the relevant data gathered from the data collection layer.

Next, the feature selection layer uses artificial intelligence methodology to obtain the most relevant collected data streams based on the various specifications above. The feature selection layer can use artificial intelligence algorithm to direct the focus to specific areas of data collection based on the policy provider's input. The policy provider does not need to narrowly tailor or specifically list out the data collection nodes that are of interest in each scenario. Instead, the features selection layer recognizes the key words and phrases from the specifications in order to focus on the pertinent data streams.

Next, the policy generation layer utilizes its own artificial intelligence methodology to detect and eliminates false collected data or manipulated data. The policy generation layer can learn a pattern of behavior from the collected data, such that margins of acceptable accuracy can be created by the platform. Should certain data entry be outside the margin, the policy generation layer is able to designate the entry as abnormal. The platform can either automatically reject the abnormal data entry or alert the policy provider/client for manual clarification. Manual clarification are subsequently used to train the artificial intelligence algorithm to improve on its abnormal data detection.

Finally, the policy generation layer creates a fully customized insurance policy based on the historical data, real time data stream, selected features, and pattern of behavior determined therein. The customized insurance policy is optimized for the risk to cost factor in terms of conditions, price, and duration. This allows the policy provider to supply the client with a policy that is closely tailored to the actual habit and requirement of the client.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A system to generate customized insurance policies, comprising:
a data collection layer, including a plurality of sensors and databases, configured to obtain data from a property and generate a first input,
a feature selection layer utilizing artificial intelligence to select a plurality of policy features for a client based on a plurality of specifications generated by a policy provider and generate a second input, and
a policy generation layer, using artificial intelligence, evaluates the first input and the second, determines a pattern of behavior based the first input and second input, and generates a custom policy.

2. The system of claim 1, further comprising detecting and eliminating, through the policy generation layer, at least one set of false data and at least one set of manipulated data.

3. The system of claim 1, further comprising a cloud network to connect the data collection layer, the feature selection layer, and the policy generation layer.

4. The system of claim 1, further comprising artificial intelligence algorithm to evaluate historical detect the at least one set of false data and the at least one set of manipulated data in real time.

5. The system of claim 1, further comprising behavior determination algorithm to determine human behavior based on historical data collected from the data collection layer.

6. A computer generated method, comprising:
collecting real time data and historical data through a data collection layer,
converting the real time data and historical data into data input through the data collection layer,
receiving a plurality of specifications, through a feature selection layer, from at least one policy provider,
selecting a plurality of policy features for a client based the plurality of specifications with the feature selection layer,
generating a feature input based on the plurality of policy features through the feature selection layer,
transmitting the data input and the feature input to a policy generation layer,
using artificial intelligence to evaluate the data input and the feature input through the policy generation layer,
determining a pattern of behavior based on the data input and the feature input through the policy generation layer, and
generating a custom policy based on the pattern of behavior, the data input, and the feature input through the policy generation layer.

7. The method of claim 6, further comprising using artificial intelligence to detect false claims, false data, and manipulated data.

8. The method of claim 6, further comprising using artificial intelligence to learn from historical data from the data input and detect false data and false claim in real time.

9. A computer-implemented system to generate custom insurance policies, configured to:
collect data through a data collection layer from a plurality of sensors and databases,
collect a plurality of policy specifications through a feature selection layer from a policy provider,
generate a data input from the data and a feature input from the plurality of policy specifications,
determine through a policy generation layer a pattern of behavior based on the data input and the feature input, and
generate a custom policy, utilizing artificial intelligence, based on the pattern of behavior, the data input, and the feature input through the policy generation layer.

10. The system of claim 9, wherein the policy generation layer is further configured to learn from historical data from the data input and detect false claims, false data, and manipulated data.
